(19) United States
(12) Patent Application Publication
(10) Pub. No.: US 2020/0039726 A1
(43) Pub. Date: Feb. 6, 2020

(54) BEVERAGE CASE WITH WALLS HAVING DETACHABLE INSULATION DEVICES

(71) Applicant: Tucker Sweet, Raleigh, NC (US)

(72) Inventor: Tucker Sweet, Raleigh, NC (US)

(21) Appl. No.: 16/517,254

(22) Filed: Jul. 19, 2019

Related U.S. Application Data
(60) Provisional application No. 62/713,852, filed on Aug. 2, 2018.

(51) Int. Cl. B65D 81/38; B31B 50/26; B65D 81/36

(52) U.S. Cl. CPC B65D 81/3879; B65D 81/36; B31B 50/26

(57) ABSTRACT

Some examples of the present disclosure include a beverage case for carrying multiple beverage containers. The beverage case can include multiple walls. At least one of the walls can have a detachable insulation device that is configured to be removed from the beverage case and attached to a beverage container.

### CROSS REFERENCE TO RELATED APPLICATIONS

The application claims the benefit of priority under 35 U.S.C. § 119(e) to U.S. Provisional Patent Application No. 62/713,852, titled “Beverage Case With Walls Having Detachable Insulation Sleeves” and filed on Aug. 2, 2018, the entirety of which is hereby incorporated by reference herein.

### TECHNICAL FIELD

The present disclosure relates generally to receptacles. More specifically, but not by way of limitation, this disclosure relates to a beverage case with walls having detachable insulation devices.

### BACKGROUND

Beverage cases are generally used to hold and transport beverage containers. Typical beverage cases are cardboard boxes that hold 12, 24, or 36 individual cans or glass bottles. These beverage cases are commonly brought to events or social gatherings, where the beverages therein are served to consumers. Some consumers may wish to keep the beverage insulated from external heat sources, such as heat from the environment or heat from his or her hand. These consumers may insert the beverage into an insulation sleeve (e.g., a KOOZIE®), if one is available.

### SUMMARY

One example of the present disclosure includes a beverage case for carrying multiple beverage containers. The beverage case can include a plurality of walls defining an interior of the beverage case for receiving the multiple beverage containers. A wall among the plurality of walls has a detachable insulation device configured to be removed from the beverage case and attached to a beverage container to provide thermal insulation to the beverage container.

Another example of the present disclosure includes a method of using a beverage case having a detachable insulation device. The method can include obtaining the beverage case that has a plurality of walls defining an interior of the beverage case for holding multiple beverage containers, wherein a wall among the plurality of walls has the detachable insulation device. The method can include detaching the detachable insulation device from the wall of the beverage case; and attaching the detachable insulation device to a beverage container.

Another example of the present disclosure includes a method of manufacturing a beverage case having a detachable insulation device. The method can include providing a piece of material having a plurality of sections configured to be folded to form walls of the beverage case; causing a section among the plurality of sections to have the detachable insulation device; and folding the plurality of sections and affixing the plurality of sections together to produce the beverage case.

These examples are mentioned not to limit or define the limits of the present subject matter, but to aid understanding thereof. These and other examples are discussed in the Detailed Description, and further description is provided there. Advantages offered by various examples may be further understood by examining this specification and/or by practicing one or more examples of the claimed subject matter.

### BRIEF DESCRIPTION OF THE DRAWINGS

FIG. 1 is a perspective view of a beverage case with walls having detachable insulation devices according to some aspects.

FIG. 2 is a perspective view of a beverage case in which a detachable insulation device has been detached from a wall for use in insulating a beverage container according to some aspects.

FIG. 3 is a perspective view of the detachable insulation device of FIG. 2 wrapped around the beverage container according to some aspects.

FIG. 4 shows an example of a detachable insulation device according to some aspects.

FIG. 5 shows another example of a detachable insulation device according to some aspects.

FIG. 6 shows yet another example of a detachable insulation device according to some aspects.

FIG. 7 shows still another example of a detachable insulation device according to some aspects.

FIG. 8 shows another example of a detachable insulation device according to some aspects.

FIG. 9 shows yet another example of a detachable insulation device according to some aspects.

FIG. 10 shows still another example of a detachable insulation device according to some aspects.

FIG. 11 is a flow chart of an example of a process for using a beverage case according to some aspects.

FIG. 12 is a flow chart of an example of a process for manufacturing a beverage case according to some aspects.

### DETAILED DESCRIPTION

Certain aspects and features of the present disclosure involve a beverage case with a wall having a detachable insulation device. The insulation device can be integrated into the wall of the beverage case or otherwise affixed to the wall of the beverage case. A consumer can physically detach the insulation device from the wall of the beverage case and attach the insulation device to a beverage container (e.g., a can or glass bottle), such that the insulation device serves as a sleeve for the beverage container. Once attached to the beverage container, the insulation device can insulate the beverage from external heat sources, such as heat from the environment or the consumer's hand. The insulation device can also prevent the consumer's hand from becoming too cold when holding the beverage container. In some instances, the insulation device can act as a readily available substitute when the consumer forgets a KOOZIE® or another independent insulation sleeve.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

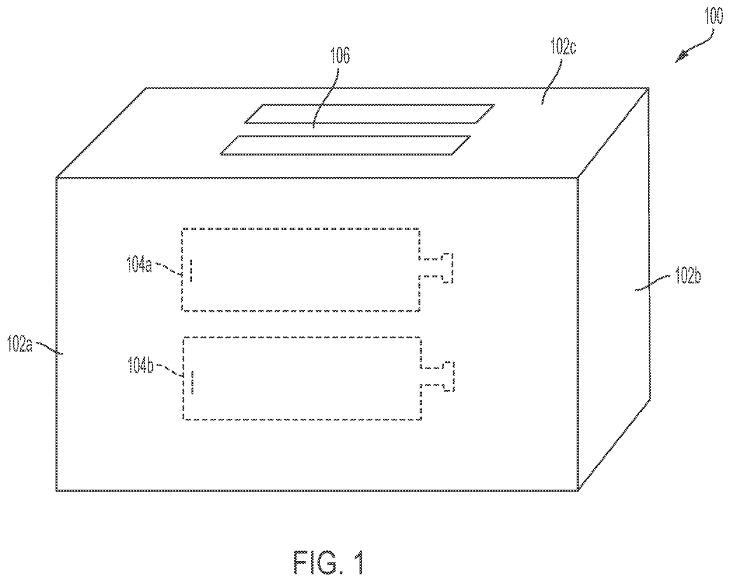

FIG. 1 is a perspective view of a beverage case 100 with walls 102a-c having detachable insulation devices 104a-b according to some aspects. In this example, the beverage case 100 is a box, but other examples can include a beverage case 100 having another shape. The beverage case 100 can include any number and combination of materials, such as cardboard, foam, or plastic.

The beverage case 100 is designed to transport beverage containers. For example, the walls 102a-c of the beverage case 100 can define an interior of the beverage case 100 for holding beverage containers. And the beverage case 100 can include a handle 106 to facilitate carrying of the beverage case 100. The handle 106 can be formed into a wall 102c of the beverage case 100 or otherwise attached to the beverage case 100.

A wall 102a of the beverage case 100 can include one or more detachable insulation devices 104a-b. In some examples, a detachable insulation device 104a can be formed from the wall 102a of the beverage case 100 such that the detachable insulation device 104a and the wall 102a form a solitary unit when the detachable insulation device 104a is not in use. For example, the wall 102a can be perforated into a shape that defines the detachable insulation device 104a. This may enable a user to easily tear or cut the detachable insulation device 104a from the wall 102a of the beverage case 100. In other examples, the detachable insulation device 104a can be attached to the wall 102a of the beverage case 100 using any suitable means. For example, the detachable insulation device 104a can be attached to the wall 102a of the beverage case 100 with an adhesive or a hook-and-loop material (e.g., VELCRO®). This may enable a consumer to easily peel or otherwise detach the detachable insulation device 104a from the wall 102a of the beverage case 100.

The detachable insulation devices 104a-b can include one or more materials, such as cardboard, foam, rubber, or plastic. For example, the detachable insulation device 104a can have a layer of foam or rubber disposed thereon for improving the insulation properties of the detachable insulation device 104a. As another example, the detachable insulation device 104a can include a water-resistant material to prevent condensation from a beverage container from being absorbed by the detachable insulation device 104a and impacting the structural integrity of the detachable insulation device 104a (e.g., to prevent the detachable insulation device 104a from becoming soggy due to the condensation).

In the example shown in FIG. 1, the wall 102a has two detachable insulation devices 104a-b. But in other examples, any number and combination of the walls 102a-c can have any number and combination of detachable insulation devices 104a-b. For example, at least two walls 102a-b of the beverage case 100 can have respective detachable insulation devices configured to be removed from the beverage case 100 and attached to respective beverage containers.

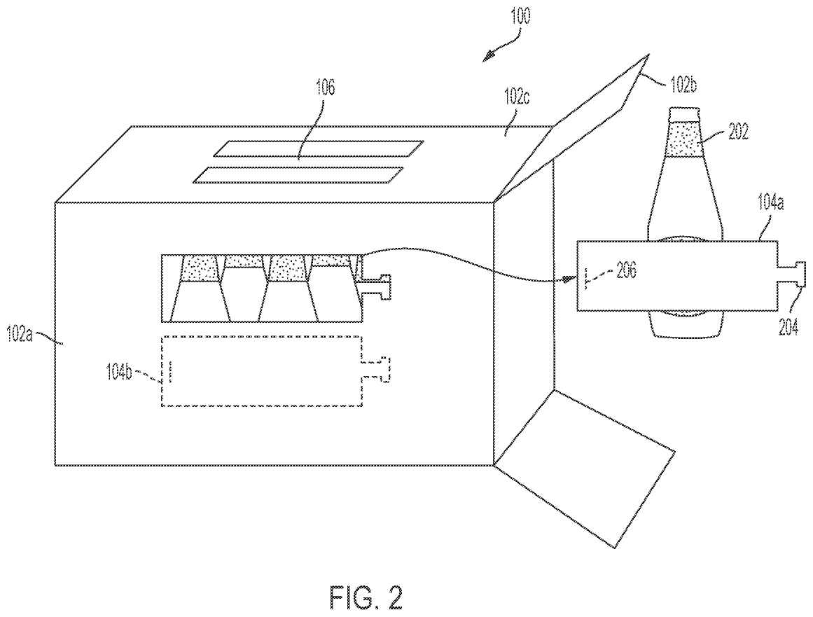

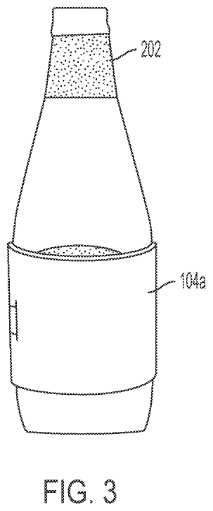

FIG. 2 is a perspective view of a beverage case 100 in which a detachable insulation device 104a has been detached from a wall 102a for use in insulating a beverage container 202 according to some aspects. In this example, the detachable insulation device 104a has a tab 204 configured to be inserted into a corresponding slot 206 proximate to an opposite end of the detachable insulation device 104a. For example, the detachable insulation device 104a can be attached to the beverage container 202 by wrapping the detachable insulation device 104a around the beverage container 202 and inserting the tab 204 into the slot 206. This can maintain the detachable insulation device 104a in a closed position, for example, as shown in FIG. 3. A consumer can then grasp the beverage container 202 via the detachable insulation device 104a to reduce thermal transfer between his hand and the beverage container 202.

In some examples, a detachable insulation device 104a can be oriented in the wall 102a perpendicularly to a direction in which the beverage container 202 is to be positioned in the beverage case 100. For example, the detachable insulation device 104a can be oriented horizontally in the beverage case 100 when the beverage containers are to be positioned vertically in the beverage case 100. This can prevent the beverage containers from falling out of the beverage case 100 after a detachable insulation device 104a has been removed from the wall 102a. The detachable insulation device 104a can be positioned at any suitable angle in a wall 102a of the beverage case 100.

While the examples shown in FIGS. 1-3 include a detachable insulation device 104a with a single tab 204, in other examples the detachable insulation device 104a can include any number and combination of tabs around any number and combination of edges of the detachable insulation device 104a. Likewise, the detachable insulation device 104a can include any number and combination of slots configured to mate with corresponding tabs.

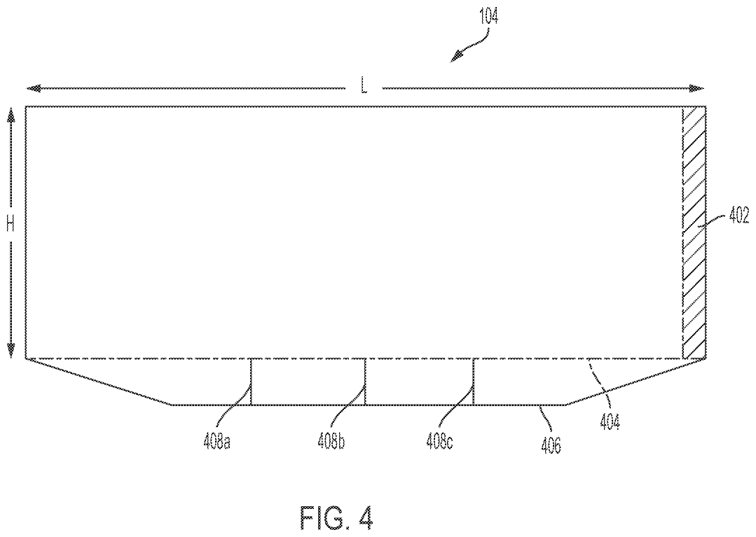

Other examples of a detachable insulation device are shown in FIGS. 4-7 and 10-12. Each of these examples can be attached to a wall of a beverage case or integrated into the wall of the beverage case. And various features of each of these examples can be combined or rearranged to create additional examples.

More specifically, FIG. 4 shows an example of a detachable insulation device 104 having an adhesive material 402, such as an adhesive layer. In this example, the adhesive material 402 is positioned at an edge of the detachable insulation device 104, but in other examples the adhesive material 402 can be positioned elsewhere on the detachable insulation device 104, such as along a length (L) of the detachable insulation device 104 for affixing the detachable insulation device 104 to a beverage container.

The adhesive material 402 can be used to attach one end of the detachable insulation device 104 to another portion (e.g., an opposite end) of the detachable insulation device 104 in order to affix the detachable insulation device 104 in a closed position. For example, the detachable insulation device 104 can be attached to a beverage container by wrapping the detachable insulation device 104 around the beverage container and affixing the adhesive material 402 to another portion of the detachable insulation device 104. Additionally or alternatively, the adhesive material 402 can be used to directly attach the detachable insulation device 104 to the beverage container in order to affix the detachable insulation device 104 to the beverage container.

In some examples, the adhesive material 402 may initially be covered with a protective layer that is removable by a consumer to reveal the adhesive material 402. This can prevent the adhesive material from becoming damaged, ineffective, or prematurely attached to an object.

The detachable insulation device 104 can also include a support member 406 configured to bend underneath a beverage container to support a base of the beverage container. This can prevent the beverage container from sliding out of the detachable insulation device 104 when the detachable insulation device 104 is in use. In this example, the support member 406 is a skirt configured to be bent by the consumer at a fold line 404 and a series of sub-fold lines 408a-c to provide the support.

The detachable insulation device 104 can have any suitable dimensions. For example, the detachable insulation device 104 can have a length of at least 101.6 millimeters (m) and a height (H) of at least 76.2 m.

In some examples, the detachable insulation device 104 can be sized to cover less than the entire circumference of a beverage container. Alternatively, the detachable insulation device 104 can be sized to cover the entire circumference of a beverage container. For example, the length of the detachable insulation device 104 can be at least 207.5 mm, which is the circumference of a standard beverage can. And, in some instances, the detachable insulation device 104 can be sized to wrap around the beverage container more than one time. This may provide additional thermal insulation or support.

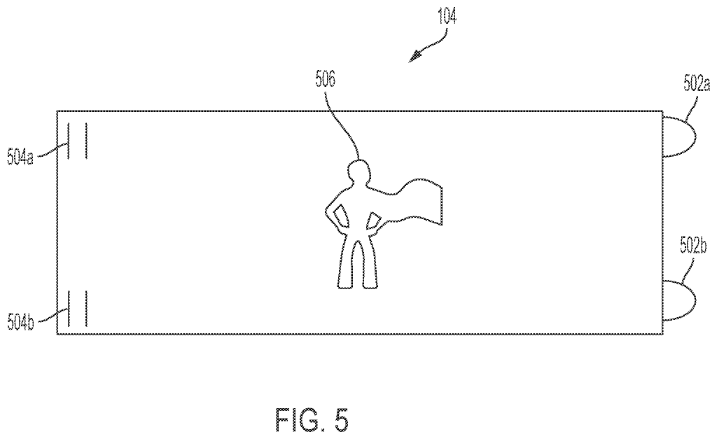

FIG. 5 shows an example of a detachable insulation device 104 having at least two tabs 502a-b configured to mate with at least two slots 504a-b. Other examples can include more or fewer tabs configured to mate with more or fewer slots, in addition or alternatively to adhesive materials.

In some examples, the detachable insulation device 104 can include a graphical element 506. The graphical element 506 may identify a beverage within a beverage container or a consumer of the beverage. For example, the graphical element can say “BEER” to identify that a beverage container has beer. Alternatively, the graphical element can include a name (e.g., “TUCKER”) or a saying (e.g., “TUCKER'S DRINK”) to help identify an owner of the beverage container. In some examples, the graphical element 506 may help distinguish the beverage container from other beverage containers. For example, different graphical elements (e.g., different superhero characters) can be applied to different detachable insulation-devices to help distinguish between beverage containers. Such graphical elements may be particularly useful in social settings where multiple consumers are drinking the same type of beverage and using detachable insulation devices from a beverage box, which may make it otherwise difficult to tell the beverage containers apart.

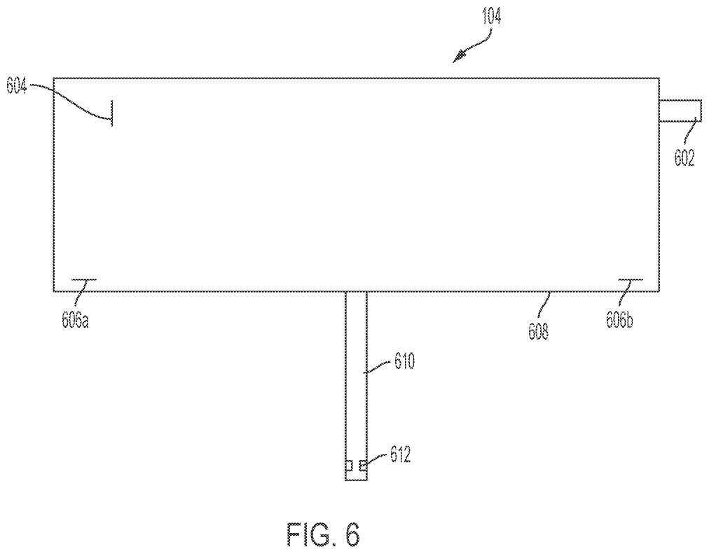

FIG. 6 shows another example a detachable insulation device 104 according to some aspects. In this example, the detachable insulation device 104 includes a tab 602 positioned to mate with a slot 604 to maintain the detachable insulation device 104 in a closed position when the detachable insulation device 104 is positioned around a beverage container. The detachable insulation device 104 also includes two other slots 606a-b positioned proximate to a bottom edge 608 of the detachable insulation device 104. When the detachable insulation device 104 is positioned around a beverage container, these other slots 606a-b can overlap one another. A support member 610 can then be wrapped underneath the beverage container and another tab 612 of the support member 610 can be inserted into the overlapping slots 606a-b, thereby maintaining the support member 610 in position. This can prevent the beverage container from slipping through the detachable insulation device 104 while in use.

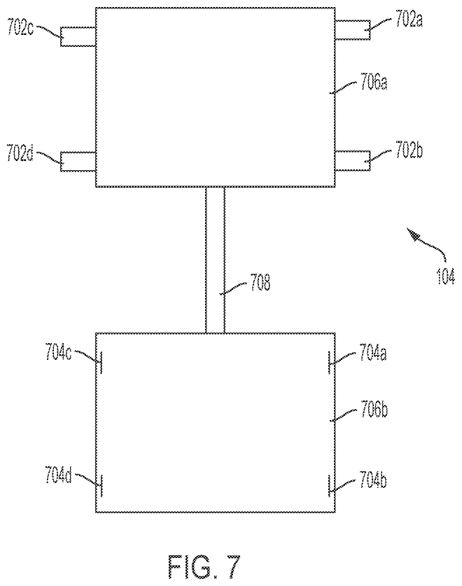

FIG. 7 shows still another example of a detachable insulation device 104 according to some aspects. The detachable insulation device 104 has two bodies 706a-b configured to be positioned around and substantially encompass opposite sides of a beverage container. Body 706a includes multiple tabs 702a-d protruding from its edges, and body 706b has multiple slots 704a-d positioned to mate with the tabs 702a-d. Each of the tabs 702a-d can be inserted into a corresponding one of the slots 704a-d to close the detachable insulation device 104 around a beverage container.

The detachable insulation device 104 further include a support member 708 coupled between the two bodies 706a-b. While the support member 708 has a rectangular shape in this example, the support member 708 can have other shapes in other examples. For example, the support member 708 can have a circular shape (e.g., a Phi shape (ϕ)). Also, while this example includes a single support member 708, other examples can include any number and combination of support members having any number and combination of shapes.

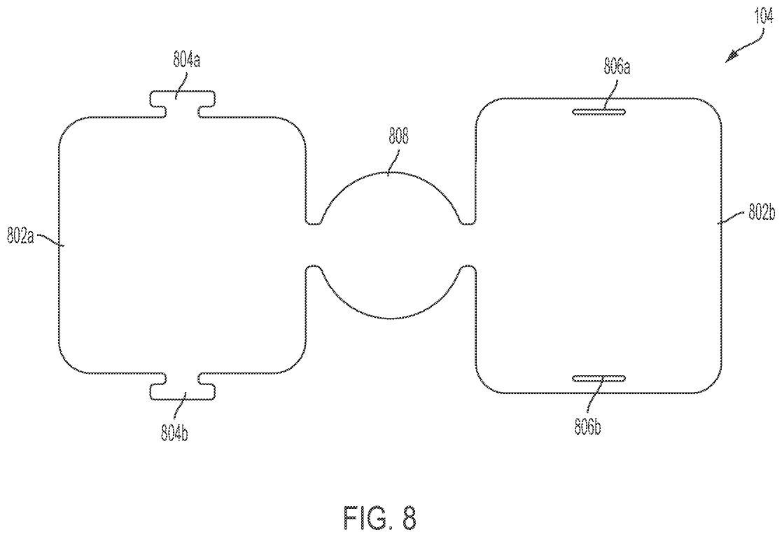

FIG. 8 shows another example of a detachable insulation device 104 according to some aspects. The detachable insulation device 104 has two bodies 802a-b configured to be positioned around and substantially encompass opposite sides of a beverage container. Body 802a includes multiple tabs 804a-b protruding from its edges, and body 802b has multiple slots 806a-b positioned to mate with the tabs 804a-b. Each of the tabs 804a-b can be inserted into a corresponding one of the slots 806a-b to close the detachable insulation device 104 around a beverage container.

The detachable insulation device 104 further include a support member 808 coupled between the two bodies 802a-b. While the support member 808 has a generally rounded shape (e.g., Phi shape (ϕ)) in this example, the support member 808 can have other shapes in other examples. For example, the support member 808 can have a rectangular shape. Also, while this example includes a single support member 808, other examples can include any number and combination of support members having any number and combination of shapes.

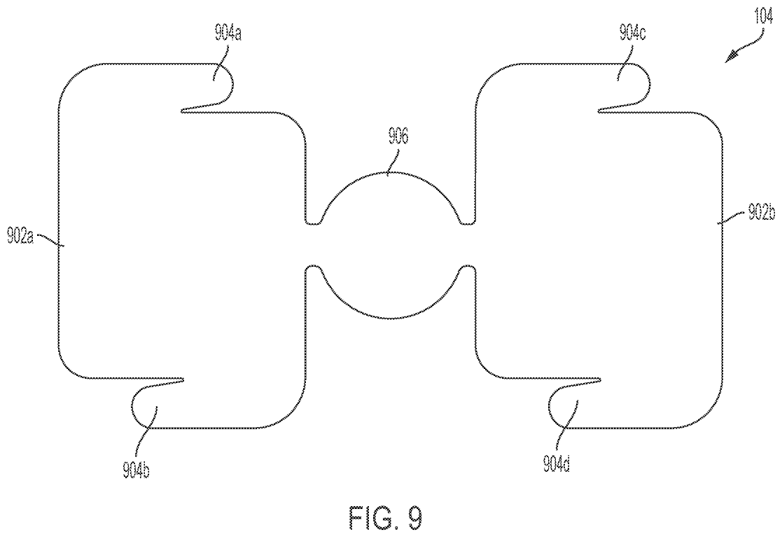

FIG. 9 shows yet another example of a detachable insulation device 104 according to some aspects. The detachable insulation device 104 has two bodies 902a-b configured to be positioned around and substantially encompass opposite sides of a beverage container. Body 902a includes interlocking members 904a-b integrated into its edges, where the interlocking members 904a-b are configured to mate with corresponding interlocking members 904c-d of body 902b in order to close the detachable insulation device 104 around a beverage container.

The detachable insulation device 104 further include a support member 906 coupled between the two bodies 902a-b. While the support member 906 has a generally rounded shape (e.g., Phi shape (ϕ)) in this example, the support member 906 can have other shapes in other examples. For example, the support member 906 can have a rectangular shape. Also, while this example includes a single support member 906, other examples can include any number and combination of support members having any number and combination of shapes.

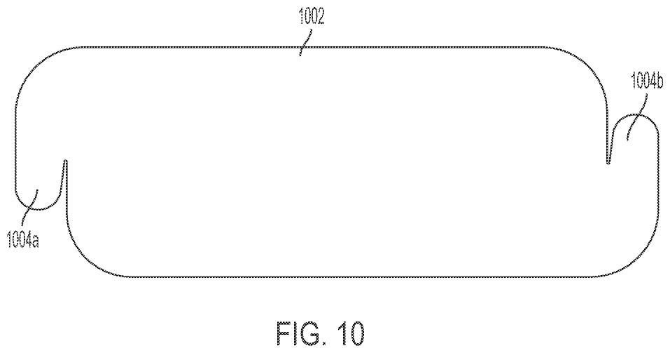

FIG. 10 shows still another example of a detachable insulation device 104 according to some aspects. The detachable insulation device 104 has a body 1002 configured to be positioned around and substantially encompass a beverage container. In this example, the body 1002 includes two interlocking members 1004a-b integrated into its edges, where the interlocking members 904a-b are configured to mate with one another in order to close the detachable insulation device 104 around a beverage container. But other examples can have more interlocking members (e.g., two interlocking members positioned at each edge of the body 1002).

Detachable insulation devices according to the present disclosure can be used any number of ways. One example of a process for using a detachable insulation device is shown in FIG. 11. Other examples can include more steps, fewer steps, different steps, or a different combination of steps than are shown in FIG. 11.

In block 1102, a beverage case is obtained. The beverage case can include a plurality of walls defining an interior of the beverage case for holding multiple beverage containers. A wall among the plurality of walls can have a detachable insulation device.

In block 1104, the detachable insulation device can be detached from the wall of the beverage case. In some examples, this can involve tearing, cutting, or peeling the detachable insulation device from the wall of the beverage case.

In bock 1106, the detachable insulation device can be attached to a beverage container. In some examples, this can involve wrapping or positioning the detachable insulation device around the beverage container. Attaching the detachable insulation device to the beverage container can provide thermal insulation to the beverage container.

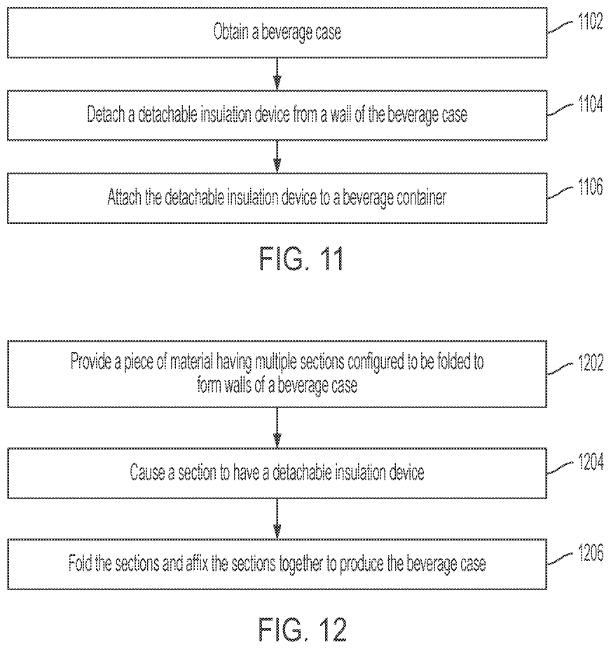

FIG. 12 is a flow chart of an example of a process for manufacturing a beverage case according to some aspects. Other examples can include more steps, fewer steps, different steps, or a different combination of steps than are shown in FIG. 12.

In block 1202, a piece of material is provided. The piece of material can have multiple sections. The sections can be configured to be folded (e.g., in a predetermined manner) to form walls of a beverage case. For example, the piece of material can have predefined fold-lines separating the sections and along which the sections are to be folded.

In block 1204, a section is caused to have a detachable insulation device. This may involve perforating the section to define the detachable insulation device or attaching the detachable insulation device to the section. In some examples, the section can be caused to have multiple detachable-insulation devices.

In block 1206, the sections can be folded and/or affixed together to produce the beverage case, which has the multiple detachable-insulation devices.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any example(s) described herein can be combined with any other example(s).

1. A beverage case for carrying multiple beverage containers, the beverage case comprising:
a plurality of walls defining an interior of the beverage case for receiving the multiple beverage containers, wherein a wall among the plurality of walls has a detachable insulation device configured to be removed from the beverage case and attached to a beverage container to provide thermal insulation to the beverage container.

2. The beverage case of claim 1, wherein the beverage case is a cardboard box having a shape defined by the plurality of walls.

3. The beverage case of claim 1, wherein the wall of the beverage case has at least two detachable insulation devices configured to be removed from the beverage case and attached to respective beverage containers.

4. The beverage case of claim 1, wherein at least two walls of the beverage case have respective detachable insulation devices configured to be removed from the beverage case and attached to respective beverage containers.

5. The beverage case of claim 1, wherein the detachable insulation device includes at least one of a foam, a rubber, or cardboard.

6. The beverage case of claim 1, wherein the detachable insulation device is attached to the wall via an adhesive.

7. The beverage case of claim 6, wherein the detachable insulation device is configured to be removed from the wall by peeling the detachable insulation device from the wall.

8. The beverage case of claim 1, wherein the detachable insulation device forms an integrated subsection of the wall and is configured to be removed from the wall via cutting or tearing.

9. The beverage case of claim 8, wherein a shape of the detachable insulation device is defined in the wall by perforations.

10. The beverage case of claim 1, wherein the detachable insulation device includes at least one tab and at least one slot, the at least one tab being configured to be inserted into at least one slot when the detachable insulation device is wrapped around the beverage container to maintain the detachable insulation device in a closed position.

11. The beverage case of claim 1, wherein the detachable insulation device includes an adhesive material on a first portion, the adhesive material being configured to be affixed to a second portion of the detachable insulation device when the detachable insulation device is wrapped around the beverage container to maintain the detachable insulation device in a closed position.

12. The beverage case of claim 1, wherein the detachable insulation device includes a support member configured to be positioned underneath the beverage container to support a base of the beverage container and prevent the beverage container from sliding out of the detachable insulation device.

13. The beverage case of claim 12, wherein the detachable insulation device includes at least two slots configured to overlap one another when the detachable insulation device is positioned around the beverage container and to receive a tab of the support member to maintain the support member in position.

14. The beverage case of claim 1, wherein:
the detachable insulation device is sized to wrap around the beverage container more than one time; or
the detachable insulation device is configured to couple with another detachable insulation sleeve to form a combined unit that is sized to wrap around the beverage container more than one time.

15. The beverage case of claim 1, wherein the detachable insulation device includes a graphical element configured to identify a beverage in the beverage container, to identify a consumer of the beverage, or to distinguish the beverage container from another beverage container.

16. The beverage case of claim 1, wherein the detachable insulation device is oriented in the wall perpendicularly to a direction in which the beverage container is to be positioned in the beverage case.

17. A method of using a beverage case having a detachable insulation device, the method comprising:
obtaining the beverage case that has a plurality of walls defining an interior of the beverage case for holding multiple beverage containers, wherein a wall among the plurality of walls has the detachable insulation device;
detaching the detachable insulation device from the wall of the beverage case; and
attaching the detachable insulation device to a beverage container.

18. The method of claim 17, wherein attaching the detachable insulation device to the beverage container includes wrapping the detachable insulation device around the beverage container at least one time.

19. A method of manufacturing a beverage case having a detachable insulation device, the method comprising:
providing a piece of material having a plurality of sections configured to be folded to form walls of the beverage case;
causing a section among the plurality of sections to have the detachable insulation device; and
folding the plurality of sections and affixing the plurality of sections together to produce the beverage case.

20. The method of claim 19, wherein causing the section to have the detachable insulation device comprises:
perforating the section in a shape that defines the detachable insulation device; or
attaching the detachable insulation device to the section.
